(19) United States
(12) Patent Application Publication
(10) Pub. No.: US 2008/0244224 A1
(43) Pub. Date: Oct. 2, 2008

(54) Scheduling a direct dependent instruction

(76) Inventors: Peter Sassone, Austin, TX (US); Jeff Rupley, Austin, TX (US); Bryan Black, Austin, TX (US)

Correspondence Address: TROP PRUNER & HU, PC, 1616 S. VOSS ROAD, SUITE 750, HOUSTON, TX, 77057-2631, US

(21) Appl. No.: 11/729,711

(22) Filed: Mar. 29, 2007

(51) Int. Cl. G06F 15/00

(52) U.S. Cl. 712/23

(57) ABSTRACT

In one embodiment, the present invention includes an apparatus having an instruction selector to select an instruction, where the selector is to store a dependent indicator to indicate a direct dependent consumer instruction of a producer instruction, a decode logic coupled to the instruction selector to receive the dependent indicator when the producer instruction is selected and to generate a wakeup signal for the direct dependent consumer instruction, and wakeup logic to receive the wakeup signal and to indicate that the producer instruction has been selected. Other embodiments are described and claimed.

### BACKGROUND

Processors execute instructions that have been scheduled by a scheduling unit of the processor. Although large scheduling windows may be effective at extracting instruction level parallelism (ILP), the implementation of these larger windows at high frequency is challenging. A scheduling window includes a collection of unscheduled instructions that may be considered for scheduling in a given time frame, and also includes associated tracking logic. The tracking logic maintains ready information (based on dependencies) for each instruction in the window. Instructions in the scheduling window may be held in a given cycle if all dependencies for the instruction have not yet been resolved.

Large scheduling windows can incur relatively slow select and wakeup operations within an instruction scheduler. For instance, a traditional large scheduling window includes logic to track incoming tag information and to record ready state information for unscheduled instructions.

### BRIEF DESCRIPTION OF THE DRAWINGS

FIG. 1 is a block diagram of a processor in accordance with one embodiment of the present invention.

FIG. 2 is a block diagram of a scheduler in accordance with an embodiment of the present invention.

FIG. 3 is a flow diagram of a method in accordance with one embodiment of the present invention.

FIG. 4 is a block diagram of a multiprocessor system in accordance with an embodiment of the present invention.

### DETAILED DESCRIPTION

In various embodiments, a direct dependent instruction can be identified and its corresponding producer instruction, which may generate a result or side effect on which another instruction, i.e., a consumer instruction, depends can be notified of the direct dependency so that improved speed of waking up the dependent instruction may occur during scheduling operations, improving performance. In one embodiment, a direct dependent instruction is one or more (i.e., one, two, or three) instructions (“consumer instructions”) that are the first, in program order, to use as a source operand a result from an earlier instruction in program order (“producer instructions”). In other embodiments, a direct dependent instruction may be other instructions that use data produced by a producer instruction.

Thus a fast direct access, or “wakeup”, of the first (or multiple) dependent instructions may be realized regardless of a loop delay of a primary scheduling loop, which may include further hardware and latencies, in one embodiment. Such a direct wakeup may be based on the observation that, in at least one embodiment, most instructions may have only one dependent, if any, present within a scheduler. A fast wakeup may be achieved, in one embodiment, via an auxiliary wakeup mechanism that bypasses conventional broadcast logic of a tag bus that is broadcast to wakeup logic. As a result, the primary scheduler loop may have relaxed design constraints, as it is less critical in that this primary path is only critical when an instruction has more than one consumer in the scheduler. For example, instead of a one-cycle scheduler, a two-cycle scheduler may be implemented, providing for relaxed timing constraints using the auxiliary bypass mechanism, which may issue bypass signals in a single cycle. In this way, scheduler size may be increased to recapture any possible performance loss and achieve speed up. Furthermore, by reducing design constraints on the primary scheduler, power of the primary schedule loop may be reduced by using slower, lower power transistors and other devices.

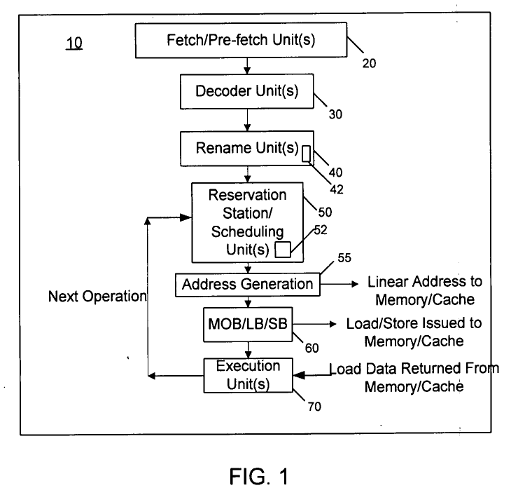

Referring now to FIG. 1, shown is a block diagram of a processor core in accordance with one embodiment of the present invention. Furthermore, the core illustrated in FIG. 1 may execute instructions or sub-instructions (e.g., micro-operations, or “uops”) in program order (“in-order execution”) or in a different order than program order (“out-of-order execution”). Moreover, the core illustrated in FIG. 1 may be included with other cores in a multi-core processor or in a single-core processor.

As shown in FIG. 1, processor 10 may be a multi-stage pipeline processor. Note that while shown at a high level in FIG. 1 as including six stages, it is to be understood that the scope of the present invention is not limited in this regard, and in various embodiments more or fewer than six such stages may be present. As shown in FIG. 1, the pipeline of processor 10 may begin at a front end with an instruction fetch stage 20 in which instructions are fetched from, e.g., an instruction cache or other location.

From instruction fetch stage 20, data passes to an instruction decode stage 30, in which instruction information is decoded, e.g., an instruction is decoded into microoperations (μLops). From instruction decode stage 30, data may pass to a register renamer stage 40, where data needed for execution of an operation can be obtained and stored in various registers, buffers or other locations. Furthermore, renaming of registers to associate limited logical registers onto a greater number of physical registers may be performed.

Still referring to FIG. 1, when needed data for an operation is obtained and present within the processor's registers, control passes to a back end stage, namely reservation/scheduling units 50, which may be used to assign an execution unit for performing the operation and provide the data to the execution unit. Selecting operations in accordance with an embodiment of the present invention may be performed in portions 42 and 52 of register renamer stage 40 and reservation/scheduling units 50. Addresses may be generated in an address generator unit 55, to which are coupled various storage units 60, such as a memory order buffer (MOB), a store buffer (SB) and a load buffer (LB), which may be in communication with memory and/or cache. Upon execution in one of or more execution units 70, the resulting information is provided to reservation/scheduling units 50 and, e.g., buffers 60, until written back, e.g., to lower levels of a memory hierarchy, such as a cache memory, a system memory coupled thereto, or an architectural register file.

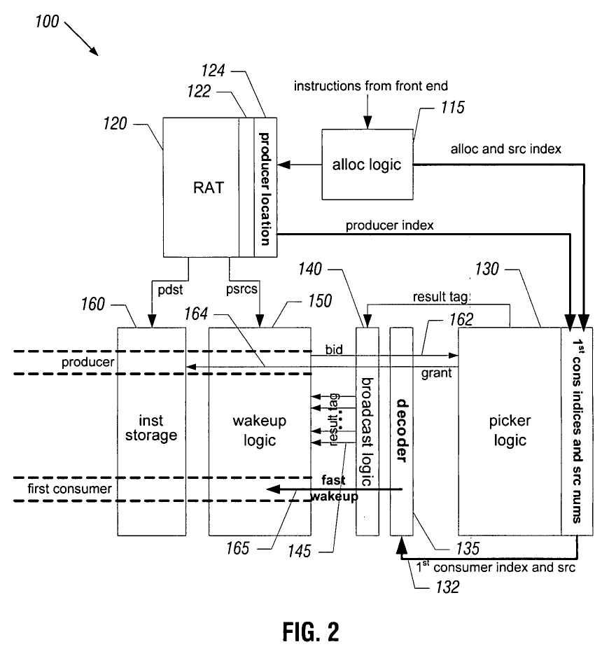

Referring now to FIG. 2, shown is a block diagram of a scheduler in accordance with an embodiment of the present invention. As shown in FIG. 1, scheduler 100 may be used to perform a wakeup of a direct dependent instruction by bypassing a broadcast mechanism within the scheduler. As shown in FIG. 2, scheduler 100 includes a register alias table (RAT 120) that is used as a table to map an instruction's architectural register identifiers to physical register identifiers. RAT 120 further includes at least a first column 122 and a second column 124 in addition to the architectural and physical register identifiers. First column 122 may be used to track the scheduler entry number that produces the last version of the architectural register with respect to the given entry. Second column 124 may be used to track how many consumers of a register have allocated. Second column 124 thus may be used to indicate whether a given consumer instruction entry is a direct dependent instruction. In an implementation in which only the first dependent instruction is the direct dependent instruction, second column 124 may be a single bit to indicate whether a given instruction is the first dependent instruction. In other implementations, second column 124 may include multiple bits to indicate the number of instructions dependent on a given instruction.

As shown in FIG. 2, incoming instructions from a front end of a processor may be provided to allocation logic 115 that allocates instructions into RAT 120. Furthermore, allocation logic 115 is coupled to a picker logic 130 that performs selection of a given instruction for issuance from scheduler 100. As shown in FIG. 2, an allocation and source index may be provided from allocation logic 115 to picker logic 130 when an instruction is allocated into RAT 120.

As further shown in FIG. 2, scheduler 100 includes a decode logic 135 to receive indications on a bypass path 132 when a direct dependent instruction is present in scheduler 100 for a selected producer instruction. Also present is broadcast logic 140, which may be used to receive a result tag from picker logic 130 when a given instruction is selected for execution. Broadcast logic 140 generates a result tag that is passed on a result bus 145 to a wakeup logic 150. Wakeup logic 150 may include entries for each associated instruction in an instruction storage 160. Each entry in wakeup logic 150 may include various indicators, such as ready indicators to indicate when information needed by a given instruction, i.e., source registers, are present in the needed location, e.g., in a register file. As further shown in FIG. 2, RAT 120 may provide pointers, i.e., source pointers (PSRCS) to wakeup logic 150 and destination pointers (i.e., PDST) to instruction storage 160.

In operation, when wakeup logic 150 determines that all needed values for performing an instruction are ready (e.g., a producer instruction in the embodiment of FIG. 2), a bid request 162 is sent to picker logic 130. In turn, picker logic 130 selects a given instruction for execution. For purposes of illustration, assume that a direct dependent consumer instruction is selected for execution. Picker logic 130 thus sends a grant signal 162 to the corresponding entry in instruction storage 160 such that the instruction is provided to an execution unit, e.g., a floating point unit, integer unit or so forth, for execution.

In various embodiments, to avoid the delay of a primary schedule loop (i.e., involving broadcast logic 140) which generates and sends a result tag on result bus 145, when a producer instruction has been selected for execution, i.e., via grant signal 164 (in response to a bid signal 162), an index and source number corresponding to the direct dependent instruction may be sent to decode logic 135 on bypass path 132 which generates a fast wakeup signal 165 that in turn sets a ready indicator for the corresponding entry within wakeup logic 150. If all values are then ready, this in turn will cause generation of a bid request and possibly a grant signal to enable the direct dependent instruction to issue from instructions storage 160 to a given execution unit.

While shown with this particular implementation in the embodiment of FIG. 2, the scope of the present invention is not limited in this regard. Furthermore, note that the implementation of the bypass path is generally orthogonal to the choice of the primary broadcast/wakeup path. In this way, various source content addressable memory (CAMs), wakeup matrix, or other design alternative may be used for the primary path.

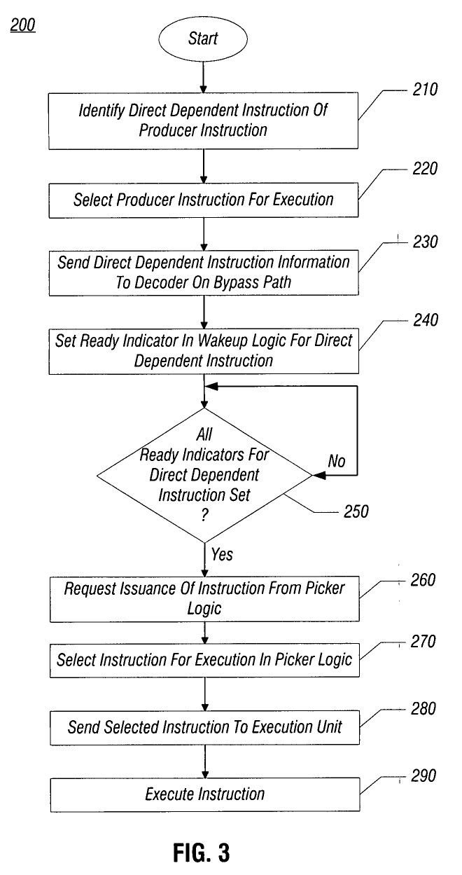

Referring now to FIG. 3, shown is a flow diagram of a method in accordance with one embodiment of the present invention. As shown in FIG. 3, method 200 may be used to perform bypass operations with regard to a direct dependent instruction in accordance with an embodiment of the present invention. As shown in FIG. 3, method 200 may begin by identifying a direct dependent instruction of a producer instruction (block 210). For example, based on information present in a RAT or other renamer logic, a direct dependent instruction may be identified. During operation, the corresponding producer instruction may be selected for execution (block 220).

When this happens, information regarding the direct dependent instruction may be decoded (block 230). This decoding operation may be performed using a bypass path. Note that in parallel with this bypass path performing direct dependent instruction decoding, conventional tag broadcast processing may be performed.

Referring still to FIG. 3, at block 240 a ready indicator may be set in wakeup logic for the direct dependent instruction (block 240). For example, a wake bit for a source operand that corresponds to a destination operand of the producer instruction may be set. Next, it may be determined whether all ready indicators for the direct dependent instruction are set (diamond 250). If not, diamond 250 may loop back on itself. If instead all the ready indicators are set, control passes to block 260, where issuance of the instruction from a picker logic may be requested (block 260). For example, a bid signal may be sent to the picker logic. Then at block 270, an instruction may be selected for execution in the picker logic. Thus, a grant signal is sent to an instruction storage to thus cause the selected instruction to be sent to an execution unit (block 280). Finally, the instruction may be executed (block 290) and a result stored in a destination storage, which may be coupled to the execution unit via result bus, for example. While shown with this particular implementation in the embodiment of FIG. 3, the scope of the present invention is not limited in this regard.

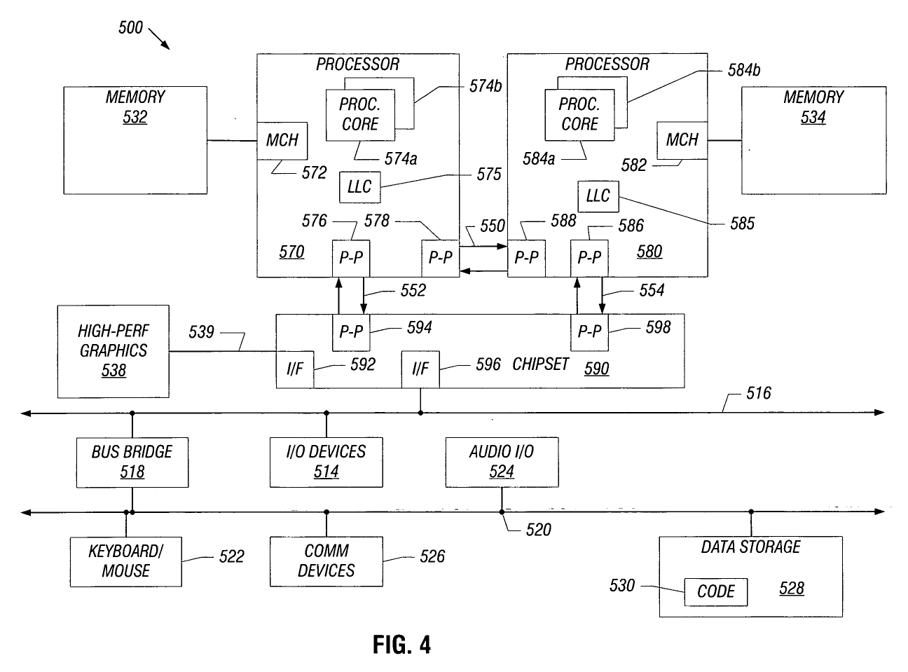

Embodiments may be implemented in many different system types. Referring now to FIG. 4, shown is a block diagram of a multiprocessor system in accordance with an embodiment of the present invention. As shown in FIG. 4, multiprocessor system 500 is a point-to-point interconnect system, and includes a first processor 570 and a second processor 580 coupled via a point-to-point interconnect 550, although a multi-drop bus such as a front side bus (FSB) implementation or another implementation is possible. As shown in FIG. 4, each of processors 570 and 580 may be multi-core processors including first and second processor cores (i.e., processor cores 574a and 574b and processor cores 584a and 584b) that may implement scheduling in accordance with an embodiment of the present invention, although other cores may be present. As shown in FIG. 4 a last-level cache memory 575 and 585 may be coupled to each pair of processor cores 574a and 574b and 584a and 584b, respectively.

Still referring to FIG. 4, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 4, MCH's 572 and 582 couple the processors to respective memories, namely a memory 532 and a memory 534 (e.g., a dynamic random access memory (DRAM)).

First processor 570 and second processor 580 may be coupled to a chipset 590 via P-P interconnects 552 and 554, respectively. As shown in FIG. 4, chipset 590 includes P-P interfaces 594 and 598 and an interface 592 to couple chipset 590 with a high performance graphics engine 538 via a bus 539. In turn, chipset 590 may be coupled to a first bus 516 via an interface 596. Various input/output (I/O) devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an instruction selector to select an instruction from a plurality of instructions for execution, the instruction selector to store a dependent indicator to indicate a direct dependent consumer instruction of a producer instruction;
a decode logic coupled to the instruction selector to receive the dependent indicator when the producer instruction is selected and to generate a wakeup signal for the direct dependent consumer instruction; and
wakeup logic coupled to the decode logic to receive the wakeup signal and to indicate that the producer instruction has been selected for execution.

2. The apparatus of claim 1, further comprising a renamer coupled to the instruction selector, wherein the renamer includes a plurality of entries each for an instruction, each entry having a first field to indicate an entry in the renamer that produces a latest version of an architectural register of the corresponding entry and a second field to indicate whether the corresponding instruction is a direct dependent.

3. The apparatus of claim 1, wherein the instruction selector is coupled to the decode logic via a bypass path.

4. The apparatus of claim 3, further comprising a broadcaster coupled to the instruction selector to receive a result tag when an instruction is selected for execution and to broadcast the result tag to the wakeup logic, wherein the broadcaster has a critical path longer than the bypass path.

5. The apparatus of claim 3, wherein the bypass path is to be used to provide the wakeup signal for only a first direct dependent instruction to the decode logic.

6. The apparatus of claim 3, wherein the bypass path is to be used to provide the wakeup signal for only a first and second direct dependent instruction to the decode logic.

7. The apparatus of claim 2, further comprising a processor including a scheduler, the scheduler including the instruction selector, the decode logic and the wakeup logic.

8. The apparatus of claim 7, further comprising a multiprocessor system including the processor.

9. A method comprising:
selecting a producer instruction for execution in an execution unit coupled to a scheduler;
providing a bypass signal from a decode logic of the scheduler to a wakeup mechanism of the scheduler on a bypass path to indicate that the producer instruction has been selected for execution if a direct dependent instruction of the producer instruction is present in the scheduler; and
setting a ready indicator for the direct dependent instruction of the producer instruction in the wakeup mechanism.

10. The method of claim 9, further comprising sending a result tag to a broadcaster of the scheduler in parallel with providing the bypass signal on the bypass path.

11. The method of claim 10, further comprising broadcasting the result tag corresponding to the producer instruction to the wakeup mechanism from the broadcaster after the bypass signal is sent.

12. The method of claim 9, further comprising:
determining if all ready indicators associated with the direct dependent instruction are set in the wakeup mechanism; and
sending a bid request to an instruction selector if all the ready indicators are set.

13. The method of claim 12, further comprising storing an entry corresponding to the direct dependent instruction in a renamer coupled to the instruction selector, the entry having a first field to indicate the producer instruction and a second field to indicate that the direct dependent instruction is the first direct dependent instruction.

14. The method of claim 9, further comprising implementing the scheduler as a two-cycle scheduler and providing the bypass signal in a single cycle.
